(19) United States
(12) Patent Application Publication
(10) Pub. No.: US 2018/0165654 A1
(43) Pub. Date: Jun. 14, 2018

(54) METHOD AND SYSTEM FOR A CONVERSATIONAL INTERFACE FOR PERSONALIZED ITINERARY EVENTS

(71) Applicant: Mastercard International Incorporated, Purchase, NY (US)

(72) Inventors: Benjamin M. BERGER, Rye Brook, NY (US); Brittney ACKERMAN, New Milford, NJ (US); Alana LIPSON, Old Westbury, NY (US); Zhichao HAN, Arlington, VA (US)

(73) Assignee: Mastercard International Incorporated, Purchase, NY (US)

(21) Appl. No.: 15/378,733

(22) Filed: Dec. 14, 2016

(51) Int. Cl. G06Q 10/10; G06Q 30/02; G06F 17/27

(52) U.S. Cl. CPC G06Q 10/1095; G06Q 30/0201; G06F 17/277; G06F 17/278; G06F 17/2785; G06F 17/2705

(57) ABSTRACT

A method for delivery of a personalized itinerary includes: storing transaction data entries, each including an account identifier and transaction data; storing event profiles, each including a geographic location, time allotment, event type, and selection criteria; receiving an itinerary request including a specific account identifier, a geographic area, and a time and date range; identifying a subset of transaction data entries where that includes the specific account identifier; identifying purchase behaviors based on the transaction data included the subset of transaction data entries; identifying a personalized itinerary comprised of a plurality of itinerary events, wherein the geographic location and selection criteria included in the related event profile corresponds to the geographic area and purchase behaviors, respectively, and where a number of itinerary events is based on the time allotment and the time and date range; and transmitting the personalized itinerary.

### FIELD

The present disclosure relates to the delivery of personalized event itineraries and event recommendations, specifically the use of natural language processing and historical transaction behavior for an individual to enable the delivery of events and itineraries that are customized for the individual and delivered via a natural language interface.

### BACKGROUND

Many individuals are interested in experiencing various activities, restaurants, entertainment venues, and other events that the world has to offer. However, even with the wealth of information available to individuals, such as via the Internet, it can be difficult for someone to identify and select an event that they think they may be interested in. For instance, with the vast number of restaurants that may exist in a metropolitan area, it may be difficult for an individual to not only evaluate each of these restaurants to make a selection, but to even identify all of the possibilities for evaluation.

As a result, individuals often turn to friends, relatives, colleagues, or specialized concierge services or apps for recommendations. However, such assistance may sometimes come at a price, may require the individual to provide significant information about themselves for a personalized recommendation, or may also be unable to identify or evaluate all of the possibilities to select one that may be preferable for the individual. For example, a friend or family member may have limited experience with restaurants or may not be kept apprised of newer restaurants the individual may be willing to try. Trying to provide meaningful recommendations without having to volunteer additional, accurate personal information presents a significant technical challenge.

Thus, there is a need for a technological solution that is configured to evaluate an individual's history to select events that may be preferable for the individual based on supplied criteria, but can avoid the need to disclose personal information that is not already provided by the user.

### SUMMARY

The present disclosure provides a description of systems and methods for the delivery of personalized itineraries and event recommendations. An individual's transaction behavior is analyzed for use in identifying events that an individual may be most interested in, based on their past behavior as well as the behavior of others having similar interests and transactional history. In some instances, an entire itinerary may be identified for an individual, such as when the individual is traveling to a new area, to provide the individual with a customized travel experience with a single request. In some cases, natural language processing may also be used to enable the individual to receive personalized recommendations via live messaging systems, where the individual may chat with a live person or a simulated respondent and receive personalized recommendations based on their conversation.

A method for delivery of a personalized itinerary includes: storing, in a transaction database of a processing server, a plurality of transaction data entries, wherein each transaction data entry is a structured data set related to a payment transaction including at least an account identifier and transaction data; storing, in an event database of the processing server, a plurality of event profiles, wherein each event profile is a structured data set related to an itinerary event including at least a geographic location, a time allotment, an event type, and one or more selection criteria; receiving, by a receiving device of the processing server, an itinerary request from a computing system, wherein the itinerary request includes at least a specific account identifier, a geographic area, and a time and date range; executing, by a querying module of the processing server, a query on the transaction database to identify a subset of transaction data entries where the included account identifier corresponds to the specific account identifier; identifying, by an analytical module of the processing server, one or more purchase behaviors based on the transaction data included in one or more of the transaction data entries included in the identified subset; executing, by the querying module of the processing server, a query on the event database to identify a personalized itinerary comprised of a plurality of itinerary events, wherein the geographic location and selection criteria included in the related event profile for the respective itinerary event corresponds to the geographic area and one or more purchase behaviors, respectively, and where a number of the plurality of itinerary events is based on the time allotment included in the related event profile for each of the itinerary events and the time and date range; and electronically transmitting, by a transmitting device of the processing server, the personalized itinerary to the computing system.

A method for delivery of personalized event recommendations includes: storing, in a transaction database of a processing server, a plurality of transaction data entries, wherein each transaction data entry is a structured data set related to a payment transaction including at least an account identifier and transaction data; storing, in an event database of the processing server, a plurality of event profiles, wherein each event profile is a structured data set related to an itinerary event including at least a geographic location, a time allotment, an event type, and one or more selection criteria; receiving, by a receiving device of the processing server, an event request, wherein the event request is written in natural language; processing, by a natural language processing module of the processing server, the event request to identify at least a specific event type, a geographic area, and a specific account identifier; executing, by a querying module of the processing server, a query on the transaction database to identify a subset of transaction data entries where the included account identifier corresponds to the specific account identifier; identifying, by an analytical module of the processing server, one or more purchase behaviors based on the transaction data included in one or more of the transaction data entries included in the identified subset; executing, by the querying module of the processing server, a query on the event database to identify a specific event profile based on at least a correspondence between the included event type and the specific event type, the included geographic location and the geographic area, and the included one or more selection criteria and the identified one or more purchase behaviors; and electronically transmitting, by a transmitting device of the processing server, the itinerary event related to the identified specific event profile to the computing system.

A system for delivery of a personalized itinerary includes: a transmitting device of a processing server; a transaction database of the processing server configured to store a plurality of transaction data entries, wherein each transaction data entry is a structured data set related to a payment transaction including at least an account identifier and transaction data; an event database of the processing server configured to store a plurality of event profiles, wherein each event profile is a structured data set related to an itinerary event including at least a geographic location, a time allotment, an event type, and one or more selection criteria; a receiving device of the processing server configured to receive an itinerary request from a computing system, wherein the itinerary request includes at least a specific account identifier, a geographic area, and a time and date range; a querying module of the processing server configured to execute a query on the transaction database to identify a subset of transaction data entries where the included account identifier corresponds to the specific account identifier; and an analytical module of the processing server configured to identify one or more purchase behaviors based on the transaction data included in one or more of the transaction data entries included in the identified subset, wherein the querying module of the processing server is further configured to execute a query on the event database to identify a personalized itinerary comprised of a plurality of itinerary events, wherein the geographic location and selection criteria included in the related event profile for the respective itinerary event corresponds to the geographic area and one or more purchase behaviors, respectively, and where a number of the plurality of itinerary events is based on the time allotment included in the related event profile for each of the itinerary events and the time and date range, and the transmitting device of the processing server is configured to electronically transmit the personalized itinerary to the computing system.

A system for delivery of personalized event recommendations includes: a transmitting device of the processing server; a transaction database of the processing server configured to store a plurality of transaction data entries, wherein each transaction data entry is a structured data set related to a payment transaction including at least an account identifier and transaction data; an event database of the processing server configured to store a plurality of event profiles, wherein each event profile is a structured data set related to an itinerary event including at least a geographic location, a time allotment, an event type, and one or more selection criteria; a receiving device of the processing server configured to receive an event request, wherein the event request is written in natural language; a natural language processing module of the processing server configured to process the event request to identify at least a specific event type, a geographic area, and a specific account identifier; a querying module of the processing server configured to execute a query on the transaction database to identify a subset of transaction data entries where the included account identifier corresponds to the specific account identifier; and an analytical module of the processing server configured to identify one or more purchase behaviors based on the transaction data included in one or more of the transaction data entries included in the identified subset, wherein the querying module of the processing server is further configured to execute a query on the event database to identify a specific event profile based on at least a correspondence between the included event type and the specific event type, the included geographic location and the geographic area, and the included one or more selection criteria and the identified one or more purchase behaviors, and the transmitting device of the processing server is configured to electronically transmit the itinerary event related to the identified specific event profile to the computing system.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for delivering personalized itineraries and event recommendations in accordance with exemplary embodiments.

FIG. 2 is a block diagram illustrating the processing server of the system of FIG. 1 for delivering personalized itineraries and event recommendations in accordance with exemplary embodiments.

FIG. 3 is a flow diagram illustrating a process for delivering a personalized itinerary using the system of FIG. 1 in accordance with exemplary embodiments.

FIG. 4 is a flow diagram illustrating a process for delivering a personalized event recommendation via natural language processing using the system of FIG. 1 in accordance with exemplary embodiments.

FIG. 5 is a diagram illustrating a graphical user interface for the delivery of a personalized event itinerary in accordance with exemplary embodiments.

FIG. 6 is a diagram illustrating a graphical user interface for the delivery of a personalized event recommendation via natural language processing in accordance with exemplary embodiments.

FIG. 7 is a flow chart illustrating an exemplary method for delivery of a personalized itinerary in accordance with exemplary embodiments.

FIG. 8 is a flow chart illustrating an exemplary method for delivery of personalized event recommendations in accordance with exemplary embodiments.

FIG. 9 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Delivery of Personalized Event Recommendations

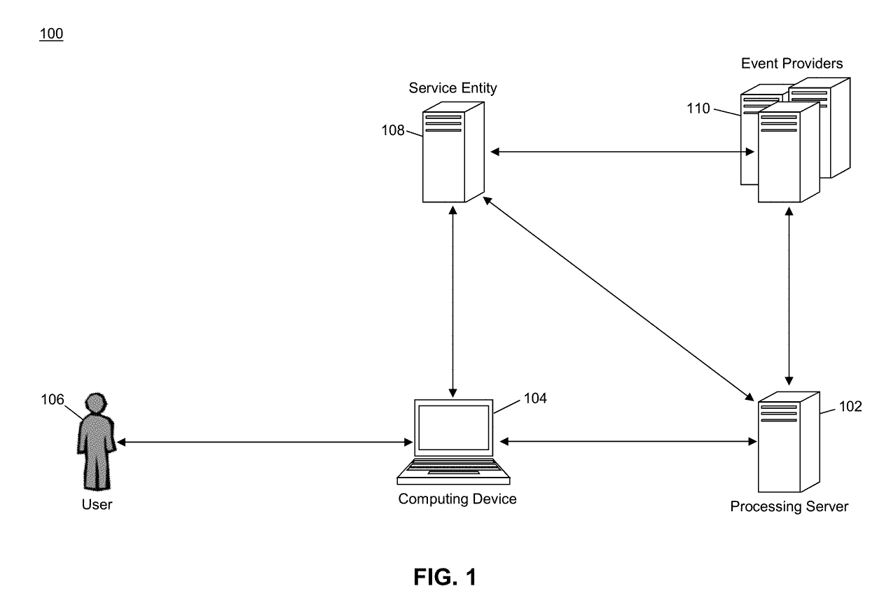

FIG. 1 illustrates a system 100 for the delivery of personalized event itineraries and event recommendations based on purchase behaviors related to historical transactional data for an individual.

The system 100 may include a processing server 102. The processing server 102, discussed in more detail below, may be configured to identify personalized event recommendations and event itineraries for an individual based on purchase behaviors associated therewith. In the system 100, the processing server 102 may receive a recommendation request from a computing device 104. The computing device 104 may be any type of computing device suitable for performing the functions discussed herein, such any specifically configured desktop computer, laptop computer, notebook computer, tablet computer, cellular phone, smart phone, smart watch, smart television, wearable computing device, implantable computing device, etc. The computing device 104 may electronically transmit a recommendation request to the processing server 102 using a suitable communication network and method, such as via a cellular communication network or the Internet.

The recommendation request may be a request for the processing server 102 to identify an event or event itinerary for a user 106 of the computing device 104. The recommendation request may include at least an account identifier associated with a transaction account (e.g., associated with the user 106) and a geographic area. The account identifier may be a unique value associated with the transaction account suitable for identification thereof, such as a primary account number, registration number, username, e-mail address, telephone number, etc. The geographic area may be an area for which the user 106 desires a recommendation. In instances where an itinerary is requested, the request may also include a time and date range for which the itinerary is requested. In some cases, the request may also include one or more event types for which recommendations are requested. For instance, the user 106 may request a recommendation for a brunch restaurant as the event type, or an itinerary request may include an event type of a sporting event, for inclusion for a sporting event in the personalized event itinerary.

Event types may include any characteristic of an event that is used for identification and/or categorization thereof. In some cases, an event may have multiple event types associated therewith, which may also include event types that are sub-types of other event types. For example, event types may include restaurants, sporting events, concerts, museums, parks, physical activities, tours, etc., where restaurants may be further divided into (e.g., or have sub-types for) cuisine types, service times, dress codes, price ranges, etc. For example, a single restaurant may have an event type identifying it as a restaurant, identifying that it serves lunch, identifying that it serves dinner, identifying its price range, identifying its cuisine type, identifying its dress code, etc.

The processing server 102 may receive the request and may identify transaction data associated with the transaction account corresponding to the account identifier included in the request. Transaction data may correspond to a plurality of payment transactions be received by the processing server 102 from one or more payment networks (e.g., processors of the payment transactions), financial institutions (e.g., as issuers or acquirers for the payment transactions), or other suitable entity or entities. Transaction data may be received for each of the plurality of payment transactions, wherein the transaction data for each payment transaction may include at least an account identifier and other suitable data, such as a transaction amount, currency type, transaction time, transaction date, geographic location, merchant name, merchant identification number, merchant category code, issuer data, acquirer data, product data, offer data, reward data, loyalty data, etc. The processing server 102 may identify transaction data associated with the transaction account corresponding to the account identifier included in the request where the transaction data includes the account identifier.

The processing server 102 may then identify purchase behaviors for the transaction account based on the identified transaction data. Purchase behaviors may be metrics associated with the behavior of the transaction account as related to payment transactions, which may include propensities for spending across a plurality of categories and may include a plurality of category groups. For instance, purchase behaviors may include propensities to spend specific amount ranges, at specific merchants, at specific merchant types, in specific geographic areas, on specific products, on specific product types, at specific times of data, on specific days of the week, etc. In cases where groups may be used, purchase behaviors may include propensities for combinations of categories, such as propensities to spend at specific merchant types (e.g., restaurants) during a specific period of time (e.g., the next thirty days), or a propensity to spend a specific transaction amount (e.g., over $300) at a specific merchant type (e.g., hotels). The purchase behaviors for a transaction account may be based on the transaction data from their past payment transactions, where past behavior may indicate future behavior with respect to payment transactions. For example, a user 106 that regularly stays at four-star hotels may have an extremely high propensity to stay at a four-star hotel again and a very low propensity to stay at a one-star hotel.

The processing server 102 may possess event data for a plurality of events. The event data for each event may include at least a geographic location, time allotment, event type, and selection criteria associated therewith. The geographic location may be a location of or associated with the event. The time allotment may be an amount of time and/or time and date for the event. For instance, the time allotment for a restaurant may include an average or estimated time for a customer to finish their meal, while the time allotment for a concert may be a static time and date at which the concert will take place. The selection criteria may include criteria associated with purchase behaviors for the identification of the corresponding event. In some instances, the selection criteria may be comprised of the event types for the event, or may include similar or related data. For example, selection criteria for a restaurant may include cuisine type, price range, dress code, specific menu items, etc., and selection criteria for a museum may include art type, art classification, exhibit types, specific artists or artworks included therein, etc. Event data may be received by the processing server 102 from a plurality of event providers 110 associated therewith, where the event providers may provide the event data to the processing server 102 using suitable communication networks and methods.

Once purchase behaviors for the transaction account have been identified, the processing server 102 may identify one or more event recommendations for the user 106. In instances where a single event was requested, the processing server 102 may identify an event having the same event type as requested, and where the event is located in the same geographic area. In instances where an event itinerary was requested, the processing server 102 may identify a plurality of events located in the same geographic area (e.g., with any requested event types incorporated) such that the time and date range is satisfied. Events may be identified based on the associated event types and correspondences between the selection criteria and the purchase behaviors identified for the user 106.

For example, the user 106 may request an itinerary for a visit to a new city for a specific two day period of time. The processing server 102 may identify their transaction behaviors and recommend restaurants for meals each of the two days that are similar (e.g., in cuisine, type, and price) to restaurants frequented by the user 106 or that the user 106 has a high propensity for, and recommend other events for the user 106 based on their purchase behaviors, such as recommending a series of museums based on the user's history of frequenting museums, where the museums may be of a type (e.g., sculpture) preferred by the user 106 by their past purchases.

In some embodiments, the processing server 102 may identify events for recommendation based on actions of other, similar users 106. For example, the processing server 102 may identify the purchase behaviors for the user 106 and may identify a different individual that has similar purchase behaviors that includes transaction data for payment transactions located in the geographic area specified by the user 106. The processing server 102 may then select events based on the transaction history of the related individual. For instance, the purchase behaviors may indicate that the user 106 has the same love for hiking and Mexican restaurants as an individual located where the user 106 will be traveling, where the processing server 102 may include hiking trails and Mexican restaurants in the itinerary frequented by the other individual.

The processing server 102 may electronically transmit the recommended event and/or event itinerary to the computing device 104 using a suitable communication network and method. The computing device 104 may then present the recommendation(s) to the user 106. In some instances, the user 106 may be able to request replacement or modification to one or more events in the itinerary. For instance, the user 106 may indicate that they want a different recommendation for a specific event, and may indicate selection criteria to be used in identifying the replacement recommendation. The processing server 102 may receive (e.g., via the computing device 104) the selection criteria and may identify another event having the same or a related event type and time allotment that complies with the selection criteria, and update the event itinerary accordingly. The user 106 may continue to repeat the process to customize the event itinerary to their liking, while still relying on the personalized recommendations provided by the processing server 102. In some cases, the computing device 104 may be configured to enable the user 106 to modify the placement of events in the itinerary, such as to switch event times or days for events. In some embodiments, the computing device 104 and/or processing server 102 may be configured to save the identified event itinerary for later retrieval by the user 106.

In some cases, the processing server 102 may be configured to place events in an event itinerary based on geographic locations associated therewith. For instance, the processing server 102 may identify a plurality of events based on the user's purchase behaviors and the event selection criteria, but may order the events in the event itinerary based on their geographic locations. For example, the processing server 102 may order the event itinerary such that there is minimal travel distance between events or such that a day's events may start and end near the user's hotel (e.g., which may also be an event identified as part of the personalized event itinerary). In some instances, the processing server 102 may also identify transportation methods as part of the recommendation of events in an event itinerary, such as by recommending the renting of a vehicle as an event or including transportation maps or public transportation services as part of the itinerary to aid the user 106 in traveling from one itinerary event to another.

In some embodiments, the processing server 102 or computing device 104 may be configured to assist the user 106 in reserving or purchasing recommended events. For instance, the user 106 may indicate, via the computing device 104, that they are satisfied with a recommended event or event itinerary. The computing device 104 or processing server 102 may then communicate with the associated event providers 110 to place reservations, purchase tickets, book rooms, buy transportation, or otherwise facilitate the eventual fulfillment of the event itinerary. In some embodiments, the system 100 may utilize one or more third party service entities 108 to perform such actions. For example, the service entity 108 may be a travel agent, where the computing device 104 may electronically transmit the event itinerary and account details for a transaction account used to fund corresponding purchases to the service entity 108, where the service entity 108 may then perform all the purchases and reservations necessary for the user 106.

In an exemplary embodiment, the processing server 102 may utilize natural language processing as part of an interface for delivering personalized event recommendations and itineraries to the user 106. For instance, the computing device 104 may include a live messaging application or other suitable application program configured for the exchange of digital conversation messages between the user 106 and another entity, where the other entity may be a user of the processing server 102 or an individual associated therewith or a virtual user. For instance, in one embodiment, the user 106 may participate in a digital conversation with a travel agent (e.g., of the service entity 108) and may submit natural language messages to the travel agent via the computing device 104 as part of the digital conversation. The processing server 102 may be configured to receive the natural language messages (e.g., via the computing device 104 directly or the service entity 108, as applicable) and may be configured to analyze and process the natural language messages to parse data therefrom. The processing server 102 may, for example, be configured to process a natural language message to identify it as a recommendation request and identify the data included therein.

For instance, the user 106 may send a message that reads “I am traveling to Boston from December 7th to the 11th and would like a personalized itinerary for my trip.” The processing server 102 may process the message to identify it as a recommendation request for an event itinerary with the geographic area being Boston and the time and date range being from December 7th through the 11th. If the user 106 has not already provided their account identifier, the processing server 102 may indicate (e.g., to the computing device 104 or service entity 108, as applicable) that such information is requested, where a natural language message may be submitted to the user 106 via the digital conversation to request the identifier (e.g., “Sounds good! Please provide us with your account ID and we'll get started!”).

In some cases, the processing server 102 may be configured to generate natural language responses, including for the delivery of an event itinerary or event recommendations. For example, the processing server 102 may identify a restaurant for recommending to the user 106 and may generate a response that reads, “How about the PTO Café for dinner tonight? It is known for its bar food and relaxed atmosphere,” incorporating the restaurant name and selection criteria (the cuisine type and atmosphere) used to identify the event. In such embodiments, the processing server 102 may be configured to accommodate modifications to an event itinerary also using natural language processing. For instance, the user 106 may receive the event itinerary and may submit, “I think it will be too cold to watch a football game in Boston in December,” where the processing server 102 will recognize the message as a request to replace the itinerary event for a football game with a different event, where the processing server 102 may respond with, “Then how about seeing the Boston Celtics on the same night?” as basketball is played indoors.

In some instances, the processing server 102 may be configured to request and accept feedback from the user 106 regarding provided event itineraries and event recommendations. For instance, following the travel or recommended event by the user 106, the user 106 may (e.g., via the computing device 104) submit feedback to the processing server 102 regarding the travel itinerary, itinerary items, and/or event recommendations. Feedback may include, for instance, comments, reviews, ratings, preferences, etc. The processing server 102 may receive the feedback, which may be stored in an account profile for the user 106 for use in identifying and recommending future itinerary items, and/or stored in a database in the processing server 102 for use in identifying and recommending future itinerary items and events for other users, such as users similar to the user 106. For example, the user 106 may try a new type of restaurant based on an event recommendation that they do not like, and may provide feedback accordingly. The processing server 102 may then not recommend similar types of restaurants to the user 106 for future travels. Similarly, users that prefer restaurants in common with the user 106 may provide negative feedback for a new restaurant in town, which the processing server 102 may refrain from recommending to the user 106 when requesting a new place to eat.

The methods and systems discussed herein enable a user 106 to receive personalized event and itinerary recommendations based on their purchase behaviors, which may also be delivered as part of a natural language conversation system. Such methods may improve the identification of recommendations for a user 106, by taking into account their past purchase history, as well as, in some cases, the purchase history of similar individuals, but may also do so in a manner that is more easily accessible and usable by the user 106 that does not require a specialized interface. For instance, the processing server 102 may receive conversational messages using existing messaging applications, negating the need for specialized interfaces to be developed or specially associated application programs to be developed or used by the user 106. As such, the methods and systems discussed herein may provide for event and itinerary recommendations with both greater accuracy as well as significantly greater convenience.

### Processing Server

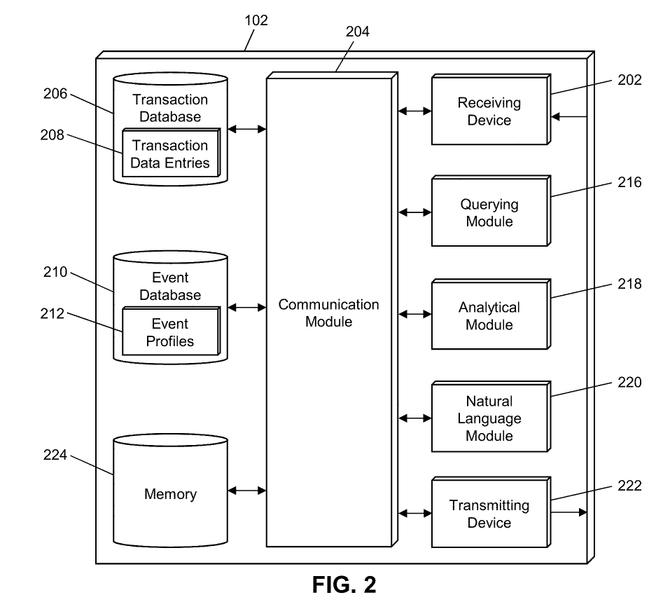

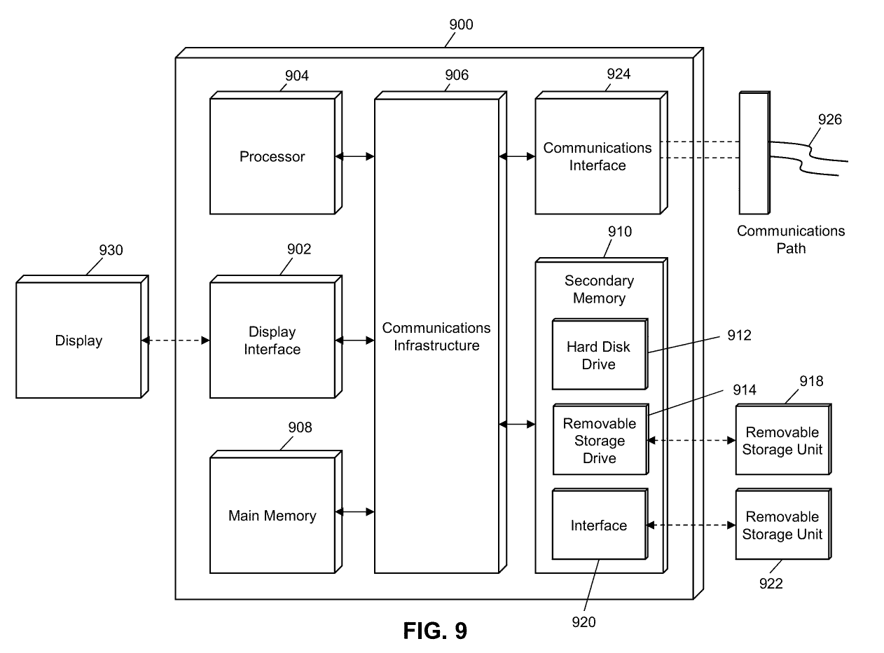

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 900 illustrated in FIG. 9 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data from computing devices 104, service entities 108, event providers 110, and other entities via one or more communication networks, such as local area networks, cellular communication networks, the Internet, etc. The receiving device 202 may also be configured to receive data over specially configured payment rails associated with a payment network, which may be specialized infrastructure associated therewith. In some embodiments, the receiving device 202 may be comprised of multiple devices, such as different receiving devices for receiving data over different networks, such as a first receiving device for receiving data via a cellular communication network and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by computing devices 104 and/or service entities 108, which may be superimposed or otherwise encoded with recommendation requests, which may request personalized event recommendations or event itinerary recommendations. In some instances, the requests may be received as natural language messages received via a live message application or other suitable digital conversation application. In some cases, requests may be received via an application programming interface associated with the processing server 102. The receiving device 202 may also be configured to receive data signals electronically transmitted by event providers 110, which may be superimposed or otherwise encoded with event data. The receiving device 202 may also be configured to receive data signals electronically transmitted by payment networks, financial institutions, or other entities that may be superimposed or otherwise encoded with transaction data for payment transactions.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 216, analytical module 218, natural language module 220, etc. As used herein, the term “module” may be software or hardware particularly programmed to receive an input, perform one or more processes using the input, and provide an output. The input, output, and processes performed by various modules will be apparent to one skilled in the art based upon the present disclosure.

The processing server 102 may include a transaction database 206. The transaction database 206 may be configured to store a plurality of transaction data entries 208 using a suitable data storage format and schema. The transaction database 206 may be a relational database that utilizes structured query language for the storage, identification, modifying, updating, accessing, etc. of structured data sets stored therein. Each transaction data entry 208 may be a structured data set configured to store data related to a payment transaction. A transaction data entry 208 may include at least an account identifier and transaction data. The account identifier may be a primary account number or other unique value associated with a transaction account used to fund the related payment transaction. The transaction data may include any additional data associated therewith, which may be used in the identification or purchase behaviors, such as transaction amounts, geographic location, transaction times and/or dates, merchant category codes, etc.

The processing server 102 may include an event database 210. The event database 210 may be configured to store a plurality of event profiles 212 using a suitable data storage format and schema. The event database 210 may be a relational database that utilizes structured query language for the storage, identification, modifying, updating, accessing, etc. of structured data sets stored therein. Each event profile 212 may be a structured data set configured to store data related to an event. An event profile 212 may include, for example, at least a geographic location, time allotment, one or more event types, and one or more selection criteria.

The processing server 102 may include a querying module 216. The querying module 216 may be configured to execute queries on databases to identify information. The querying module 216 may receive one or more data values or query strings, and may execute a query string based thereon on an indicated database, such as the transaction database 206 or event database 210, to identify information stored therein. The querying module 216 may then output the identified information to an appropriate engine or module of the processing server 102 as necessary. The querying module 216 may, for example, execute a query on the transaction database 206 to identify a plurality of transaction data entries 208 related to a recommendation request based on the included account identifier, or execute a query on the event database 210 to identify an event profile 212 having a specific event type and where there is a correspondence between the included selection criteria and supplied purchase behaviors.

The processing server 102 may also include an analytical module 218. The analytical module 218 may be configured to perform data analysis for the processing server 102 for performing the functions discussed herein. The analytical module 218 may receive instructions as input, may perform data analysis based on the instructions, and may output a result of the analysis to another module or engine of the processing server 102. In some instances, the input of the analytical module 218 may include data for use in the analysis. In other instances, the analytical module 218 may be configured to identify data for use in the analysis, such as by instructing the querying module 216 to identify the data in the transaction database 206 or event database 210. The analytical module 218 may be configured to identify purchase behaviors based on transaction data included in a plurality of transaction data entries 208, such as may correspond to a single transaction account. The analytical module 218 may also be configured to analyze geographic locations and time allotments of a plurality of event profiles 212 to identify an event itinerary based thereon, such as to optimize usage of time or minimize traveling time between events.

The processing server 102 may also include a natural language module 220. The natural language module 220 may be configured to parse natural language messages and generate natural language messages for use by the processing server 102 in performing the functions discussed herein. The natural language module 220 may be configured to generate natural language messages, whereby the natural language module 220 may receive data to be included in the natural language message and may, using one or more algorithms associated therewith, generate the natural language message that includes the supplied data. The natural language module 220 may also be configured to identify data values in a natural language message supplied thereto, and output the data values to another module or engine of the processing server 102, such as by processing the natural language message using suitable algorithms known to persons having skill in the relevant art. For example, the natural language module 220 may be configured to identify account identifiers, geographic locations, time and/or date ranges, event types, selection criteria, etc. in natural language messages received in a digital conversation, or to generate a natural language response that includes an event recommendation and/or event itinerary. Methods for parsing and generating natural language messages will be apparent to persons having skill in the relevant art.

The processing server 102 may also include a transmitting device 222. The transmitting device 222 may be configured to transmit data over one or more networks via one or more network protocols. In some embodiments, the transmitting device 222 may be configured to transmit data to computing devices 104, service entities 108, event providers 110, and other entities via one or more networks, such as local area networks, cellular communication networks, the Internet, etc. In some embodiments, the transmitting device 222 may be comprised of multiple devices, such as different transmitting devices for transmitting data over different networks, such as a first transmitting device for transmitting data over a cellular communication network and a second transmitting device for transmitting data over the Internet. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals to computing devices 104 and/or service entities 108, which may be superimposed or otherwise encoded with event recommendations and/or event itineraries. In some instances, the event recommendations or event itineraries may be included in natural language messages submitted via a digital conversation, such as using an application program associated therewith. In some cases, the data signals may be electronically transmitted via an application programming interface of the processing server 102. In some embodiments, the transmitting device 222 may also be configured to electronically transmit data signals to event providers 110, such as may be superimposed or otherwise encoded with requests for event data or requests for reservations, purchase, or other facilitation of recommended events.

The processing server 102 may also include a memory 224. The memory 224 may be configured to store data for use by the processing server 102 in performing the functions discussed herein. The memory 224 may be configured to store data using suitable data formatting methods and schema and may be any suitable type of memory, such as read-only memory, random access memory, etc. The memory 224 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 224 may be comprised of or may otherwise include a relational database that utilizes structured query language for the storage, identification, modifying, updating, accessing, etc. of structured data sets stored therein.

### Process for Delivering a Personalized Itinerary

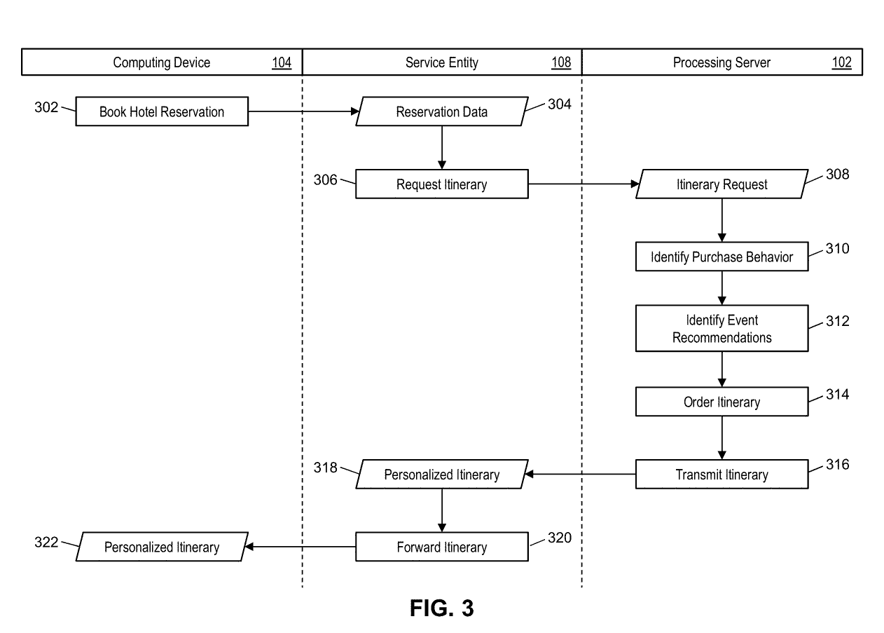

FIG. 3 illustrates a process for the delivery of a personalized itinerary in the system 100 from the processing server 102 to a computing device 104, based on purchase behaviors for an indicated transaction account, where the personalized itinerary is provided following a travel booking.

In step 302, the user 106 may use the computing device 104 to book a hotel reservation for travel. The hotel reservation may be booked through a service entity 108, such as a travel agent, which may receive reservation data for the hotel reservation, in step 304. The reservation data may include at least a geographic area where the hotel is located, and the time and date range for the stay at the hotel. The reservation data may also include an account identifier associated with a transaction account, which may be the same account used to reserve the hotel or a different account as supplied by the computing device 104. In step 306, the service entity 108 may electronically transmit an itinerary request to the processing server 102.

In step 308, the receiving device 202 of the processing server 102 may receive the itinerary request. The itinerary request may include at least the geographic area and time and/or date range of the reservation, as well as the account identifier associated with the indicated transaction account. In step 310, the querying module 216 of the processing server 102 may execute a query on the transaction database 206 to identify a plurality of transaction data entries 208 where the included account identifiers correspond to the supplied account identifier, which the analytical module 218 may use to identify a plurality of purchase behaviors for the transaction account. In step 312, the querying module 216 may execute a query on the event database 210 to identify a plurality of event profiles 212 where the included geographic location is included in the supplied geographic area, and where the included selection criteria corresponds to the identified purchase behaviors.

In step 314, the analytical module 218 of the processing server 102 may generate a personalized itinerary consisting of the identified events, where the personalized itinerary may be ordered based on event type, time allotment, geographic location, and other criteria. For instance, the analytical module 218 may only identify up to three events per day related to meals, and may select events based on external factors, such as weather, season, traveler reviews, ratings, etc. In step 316, the transmitting device 222 of the processing server 102 may electronically transmit a data signal to the service entity 108 that is superimposed or otherwise encoded with the personalized itinerary.

In step 318, the service entity 108 may receive the itinerary. In step 320, the service entity 108 may forward the personalized itinerary to the computing device 104, such as to accompany a confirmation of the hotel reservation. In step 322, the computing device 104 may receive the personalized itinerary, which may be presented to the user 106 for use in planning or executing their travels.

### Process for Event Recommendations Through Natural Language

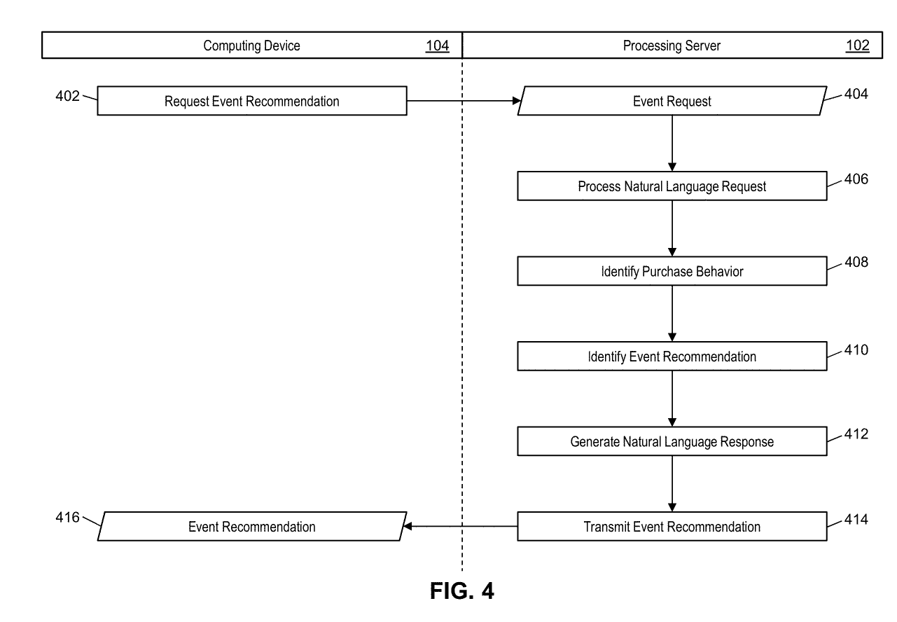

FIG. 4 illustrates a process for the delivery of an event recommendation in the system 100 based on purchase behaviors that utilizes natural language processing.

In step 402, the computing device 104 may electronically transmit a natural language message to the processing server 102 via a digital conversation method (e.g., a live messaging application program), wherein the natural language message comprises a request for an event recommendation (e.g., “What's something fun I can do here in Alexandria with my spouse tonight?”). In step 404, the receiving device 202 of the processing server 102 may receive the natural language message. In step 406, the natural language module 220 of the processing server 102 may process the natural language message to parse the data values for the event recommendation request therefrom, which may include at least the geographic area (e.g., Alexandria), a time and/or date range (e.g., tonight), and an event type (e.g., leisure activity).

In step 408, the querying module 216 of the processing server 102 may execute a query on the transaction database 206 to identify a plurality of transaction data entries 208 associated with a specific transaction account, which the analytical module 218 of the processing server 102 may use to identify one or more purchase behaviors for the transaction account based on the transaction data included therein. In the above example, the user 106 may have previously supplied an account identifier for the specific transaction account to the processing server 102 prior to requesting the event recommendation, such as during a registration process. In other instances, the processing server 102 may request the account identifier from the computing device 104 (e.g., via natural language messages, if applicable).

In step 410, the querying module 216 of the processing server 102 may execute a query on the event database 210 to identify an event profile 212 that includes an event type, time allotment, and geographic location that corresponds to the data values parsed from the event request, and where the included selection criteria corresponds to the identified purchase behaviors. In some instances, the analytical module 218 of the processing server 102 may analyze each identified event profile 212 for the selection of a single event recommendation, or a list of predetermined size of recommended events (e.g., for selection by the user 106), such as based a strength of the correspondence of the selection criteria to the purchase behaviors.

In step 412, the natural language module 220 of the processing server 102 may generate a natural language response that includes the event recommendation (e.g., “How about going to see The Inventors at the Birchmere at 7 p.m.?”). In step 414, the transmitting device 222 of the processing server 102 may electronically transmit the natural language response to the computing device 104 using the digital conversation method. In step 416, the computing device 104 may receive the event recommendation included in the natural language response, which may then be presented to the user 106. In some instances, the user 106 may, through the computing device 104, request the processing server 102 to reserve or purchase the recommended event using the indicated transaction account. In such instances, the corresponding message may be processed by the natural language module 220 and the corresponding event provider 110 notified via the transmitting device 222.

### Graphical User Interfaces

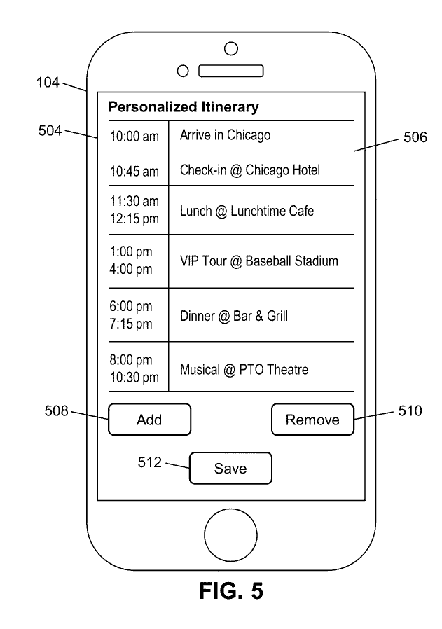

FIG. 5 illustrates a graphical user interface of the computing device 104 for the receipt and display of a personalized event itinerary delivered using the system 100. It will be apparent to persons having skill in the relevant art that the interface illustrated in FIG. 5 is provided as an illustration only, and that alternative illustrates may be suitable for performing the functions discussed herein.

The computing device 104 may include a display device 504. The display device 504 may be any type of display device suitable for displaying a personalized itinerary to the user 106, such as a liquid crystal display, light emitting diode display, thin film transistor display, capacitive touch display, etc. The display device 504 may display a personalized itinerary 506. The personalized itinerary 506 may include a plurality of events, including an event type, geographic location, and time allotment associated with each event included in the itinerary. For instance, the event itinerary 506 includes an event for lunch (e.g., the event type) at the Lunchtime Café (e.g., the geographic location) between 11:30 a.m. and 12:15 p.m. (e.g., the time allotment).

The personalized itinerary 506 may also be accompanied by an add button 508 and a remove button 510. The add button 508 may, when interacted with by the user 106, enable the user 106 to specify an additional event or criteria for the selection thereof by the processing server 102 for inclusion in the event itinerary 506. The remove button 510 may, when interacted with by the user 106, enable the user 106 to remove an existing event from the event itinerary 506. The display device 504 may also include a save button 512. The save button 512 may provide the user 106 with the ability to preserve the event itinerary 506 for recall later, such as by saving the event itinerary 506 in the application program, printing the event itinerary 506, e-mailing the event itinerary 506 to a specified e-mail address, delivering the event itinerary 506 to another application program on the computing device 104 or to the application program in another computing device 104 (e.g., belonging to a fellow traveler), sending a short messaging service message that includes the event itinerary 506 to the computing device 104 or another computing device 104 etc.

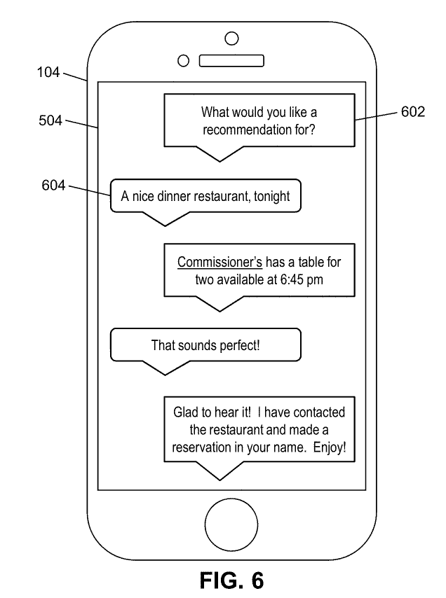

FIG. 6 illustrates a graphical user interface of the computing device 104 for the receipt and display of a digital conversation the system 100 for the receipt and display of an event recommendation using natural language processing. It will be apparent to persons having skill in the relevant art that the interface illustrated in FIG. 6 is provided as an illustration only, and that alternative illustrates may be suitable for performing the functions discussed herein.

As illustrated in FIG. 6, the display device 504 of the computing device 104 may display a digital conversation, which may be comprised of a plurality of received responses 602 and submitted messages 604. Each of the digital messages may be written in a natural language, whereby the submitted messages 604 may be submitted to the processing server 102 for processing by the natural language module 220 for parsing of data values included therein. Received responses 602 may be natural language messages generated by the natural language module 220 of the processing server 102 for presentation to the user 106 by the display device 504, which may include prompts for data, event recommendations, or other information.

In the illustrated example, the processing server 102 first prompts the user 106 for a request for an event recommendation. The user's first submitted message 604 is a request for a dinner restaurant (e.g., the event type) for that evening (e.g., the time allotment), which may be parsed therefrom by the natural language module 220. The processing server 102 may, utilizing a previously provided geographic area and account identifier for the user 106, identify a recommended dinner restaurant for that evening. The processing server 102 may then submit a received response 602 that is formatted in a natural language to suggest Commissioner's at 6:45 p.m. In the illustrated example, the processing server 102 may suggest the time and party size based on the transaction history of the user 106, or based on criteria earlier provided by the user 106 (e.g., a preferred dinner time, normal party size, etc.), which may be used absent instructions to the contrary. Also in the illustrated example, the user 106 accepts the suggested recommendation, after which the processing server 102 notifies the corresponding event provider 110 (e.g., the restaurant, a reservation service, etc.) to place the reservation, which is confirmed with the user 106. In some embodiments, the user 106 may be able to provide feedback regarding event recommendations. For instance, after the reservation, the user 106 may receive (e.g., via the computing device 104) a received response 602 requesting feedback on the event. The user 106 may submit a submitted message 604 to the processing server 102 that provides feedback (e.g., a rating, comments, review, etc.), which may be used by the processing server 102 when recommending the same event to other, similar users 106 or when recommending new events to the user 106.

### Exemplary Method for Delivery of a Personalized Itinerary

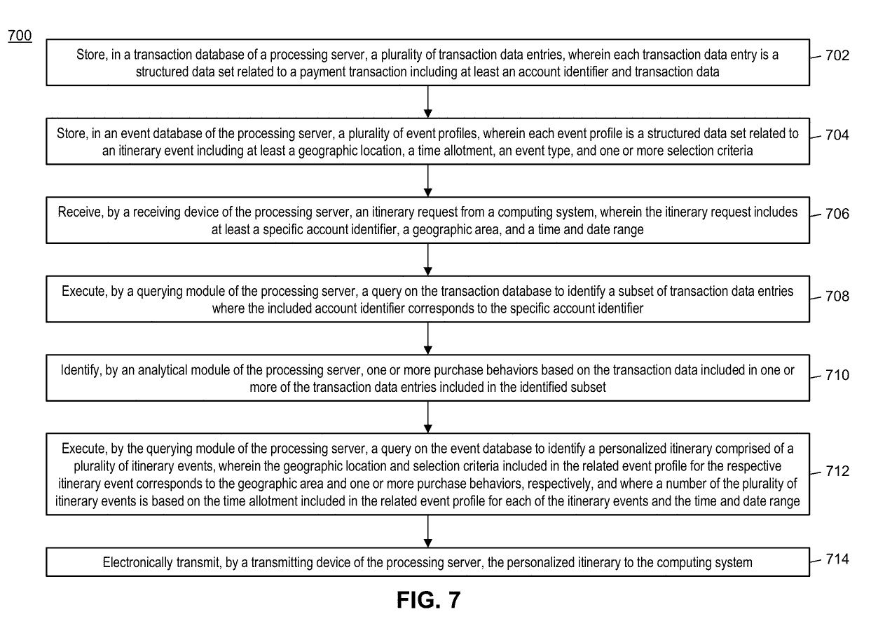

FIG. 7 illustrates a method 700 for the delivery of a personalized itinerary for a time and date range that includes a plurality of events selected based on individual purchase behavior.

In step 702, a plurality of transaction data entries (e.g., transaction data entries 208) may be stored in a transaction database (e.g., the transaction database 206) of a processing server (e.g., the processing server 102), wherein each transaction data entry is a structured data set related to a payment transaction including at least an account identifier and transaction data. In step 704, a plurality of event profiles (e.g., event profiles 212) may be stored in an event database (e.g., the event database 210) of the processing server, wherein each event profile is a structured data set related to an itinerary event including at least a geographic location, a time allotment, an event type, and one or more selection criteria.

In step 706, an itinerary request may be received by a receiving device (e.g., the receiving device 202) of the processing server from a computing system (e.g., the computing device 104), wherein the itinerary request includes at least a specific account identifier, a geographic area, and a time and date range. In step 708, a query may be executed on the transaction database by a querying module (e.g., the querying module 216) of the processing server to identify a subset of transaction data entries where the included account identifier corresponds to the specific account identifier.

In step 710, one or more purchase behaviors may be identified by an analytical module (e.g., the analytical module 218) of the processing server based on the transaction data included in one or more of the transaction data entries included in the identified subset. In step 712, a query may be executed on the event database by the querying module of the processing server to identify a personalized itinerary comprised of a plurality of itinerary events, wherein the geographic location and selection criteria included in the related event profile for the respective itinerary event corresponds to the geographic area and one or more purchase behaviors, respectively, and where a number of the plurality of itinerary events is based on the time allotment included in the related event profile for each of the itinerary events and the time and date range. In step 714, the personalized itinerary may be electronically transmitted by a transmitting device (e.g., the transmitting device 222) of the processing server to the computing system.

In one embodiment, the method 700 may further include ordering, by the analytical module of the processing server, the plurality of itinerary events based on at least the event type and time allotment included in the related event profile, wherein the ordering is performed prior to electronically transmitting the personalized itinerary. In some embodiments, the method 700 may also include: receiving, by the receiving device of the processing server, a replacement request from the computing system, wherein the replacement request indicates a selected one of the plurality of itinerary events; executing, by the querying module of the processing server, a query on the event database to identify a replacement event profile based on at least a correspondence between the included event type and time allotment and the event type and time allotment included in the event profile related to the selected itinerary event, and a correspondence between the included selection criteria and the one or more purchase behaviors; replacing, by the analytical module of the processing server, the selected one of the plurality of itinerary events with the itinerary event related to the identified replacement event profile to update the personalized itinerary; and electronically transmitting, by the transmitting device of the processing server, the updated personalized itinerary to the computing system.

In one embodiment, each transaction data entry may further include a geographic location, and the geographic location included in each transaction data entry included in the identified subset may be included in the geographic area. In some embodiments, the itinerary request may be written in natural language, and the method 700 may also include processing, by a natural language processing module (e.g., the natural language module 220) of the processing server, the itinerary request to identify the account identifier, geographic area, and time and date range.

### Exemplary Method for Delivery of Personalized Event Recommendations

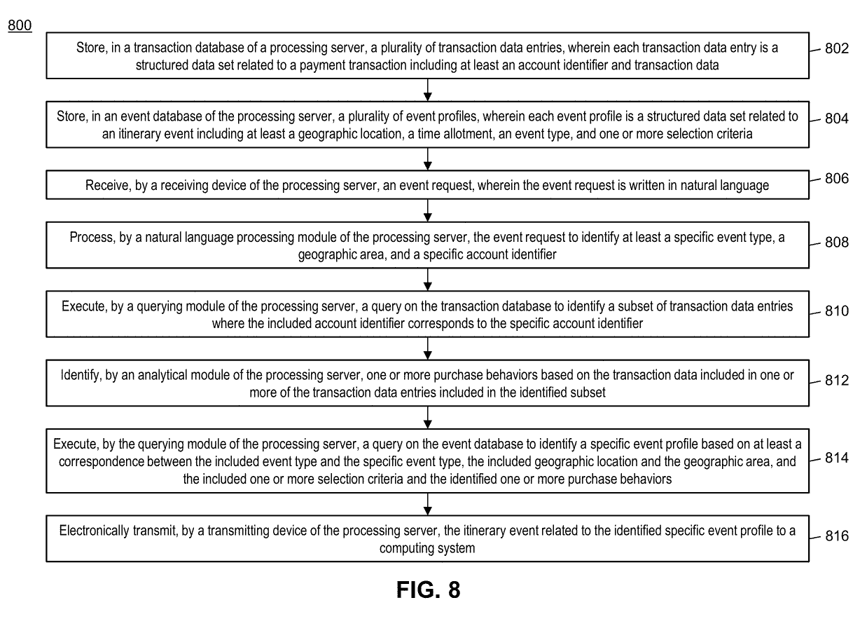

FIG. 8 illustrates a method 800 for the identification and delivery of a personalized event recommendation using natural language, where the event is recommendation based on selection criteria and personalized purchase behaviors.

In step 802, a plurality of transaction data entries (e.g., transaction data entries 208) may be stored in a transaction database (e.g., the transaction database 206) of a processing server (e.g., the processing server 102), wherein each transaction data entry is a structured data set related to a payment transaction including at least an account identifier and transaction data. In step 804, a plurality of event profiles (e.g., event profiles 212) may be stored in an event database (e.g., the event database 210) of the processing server, wherein each event profile is a structured data set related to an itinerary event including at least a geographic location, a time allotment, an event type, and one or more selection criteria.

In step 806, an event request may be received by a receiving device (e.g., the receiving device 202) of the processing server, wherein the event request is written in natural language. In step 808, the event request may be processed by a natural language processing module (e.g., the natural language module 220) of the processing server to identify at least a specific event type, a geographic area, and a specific account identifier.

In step 810, a query may be executed on the transaction database by a querying module (e.g., the querying module 216) of the processing server to identify a subset of transaction data entries where the included account identifier corresponds to the specific account identifier. In step 812, one or more purchase behaviors may be identified by an analytical module (e.g., the analytical module 218) of the processing server based on the transaction data included in one or more of the transaction data entries included in the identified subset.

In step 814, a query may be executed on the event database by the querying module of the processing server to identify a specific event profile based on at least a correspondence between the included event type and the specific event type, the included geographic location and the geographic area, and the included one or more selection criteria and the identified one or more purchase behaviors. In step 816, the itinerary event related to the identified specific profile may be electronically transmitted by a transmitting device (e.g., the transmitting device 222) of the processing server to a computing system (e.g., the computing device 104).

In one embodiment, the method 800 may further include generating, by the natural language processing module of the processing server, a natural language response, wherein the natural language response includes the itinerary event related to the identified specific event profile, and the electronic transmission of the itinerary event to the computing system comprises electronically transmitting the natural language response to the computing system. In some embodiments, the event request may be received via an application programming interface from a live messaging application executed by the computing system.

In one embodiment, each transaction data entry may further include a geographic location, and the geographic location included in each transaction data entry included in the identified subset may be included in the geographic area. In some embodiments, processing the event request may further include identifying a time and date range, and the specific event profile may be further identified based on a correspondence between the included time allotment and the time and date range.

### Computer System Architecture

FIG. 9 illustrates a computer system 900 in which embodiments of the present disclosure, or portions thereof, may be implemented as computer-readable code. For example, the processing server 102 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, 7, and 8.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 904 may be a special purpose or a general purpose processor device specifically configured to perform the functions discussed herein. The processor device 904 may be connected to a communications infrastructure 906, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 900 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/or write to the removable storage unit 918 in a well-known manner. The removable storage unit 918 may include a removable storage media that may be read by and written to by the removable storage drive 914. For example, if the removable storage drive 914 is a floppy disk drive or universal serial bus port, the removable storage unit 918 may be a floppy disk or portable flash drive, respectively. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

Data stored in the computer system 900 (e.g., in the main memory 908 and/or the secondary memory 910) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

The computer system 900 may further include a display interface 902. The display interface 902 may be configured to allow data to be transferred between the computer system 900 and external display 930. Exemplary display interfaces 902 may include high-definition multimedia interface (HDMI), digital visual interface (DVI), video graphics array (VGA), etc. The display 930 may be any suitable type of display for displaying data transmitted via the display interface 902 of the computer system 900, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 908 and secondary memory 910, which may be memory semiconductors (e.g., DRAMs, etc.). These computer program products may be means for providing software to the computer system 900. Computer programs (e.g., computer control logic) may be stored in the main memory 908 and/or the secondary memory 910. Computer programs may also be received via the communications interface 924. Such computer programs, when executed, may enable computer system 900 to implement the present methods as discussed herein. In particular, the computer programs, when executed, may enable processor device 904 to implement the methods illustrated by FIGS. 3, 4, 7, and 8, as discussed herein. Accordingly, such computer programs may represent controllers of the computer system 900. Where the present disclosure is implemented using software, the software may be stored in a computer program product and loaded into the computer system 900 using the removable storage drive 914, interface 920, and hard disk drive 912, or communications interface 924.

The processor device 904 may comprise one or more modules or engines configured to perform the functions of the computer system 900. Each of the modules or engines may be implemented using hardware and, in some instances, may also utilize software, such as corresponding to program code and/or programs stored in the main memory 908 or secondary memory 910. In such instances, program code may be compiled by the processor device 904 (e.g., by a compiling module or engine) prior to execution by the hardware of the computer system 900. For example, the program code may be source code written in a programming language that is translated into a lower level language, such as assembly language or machine code, for execution by the processor device 904 and/or any additional hardware components of the computer system 900. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 900 to perform the functions disclosed herein. It will be apparent to persons having skill in the relevant art that such processes result in the computer system 900 being a specially configured computer system 900 uniquely programmed to perform the functions discussed above.

Techniques consistent with the present disclosure provide, among other features, systems and methods for the delivery of personalized event itineraries and event recommendations. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for delivery of a personalized itinerary, comprising:
storing, in a transaction database of a processing server, a plurality of transaction data entries, wherein each transaction data entry is a structured data set related to a payment transaction including at least an account identifier and transaction data;
storing, in an event database of the processing server, a plurality of event profiles, wherein each event profile is a structured data set related to an itinerary event including at least a geographic location, a time allotment, an event type, and one or more selection criteria;
receiving, by a receiving device of the processing server, an itinerary request from a computing system, wherein the itinerary request includes at least a specific account identifier, a geographic area, and a time and date range;
executing, by a querying module of the processing server, a query on the transaction database to identify a subset of transaction data entries where the included account identifier corresponds to the specific account identifier;
identifying, by an analytical module of the processing server, one or more purchase behaviors based on the transaction data included in one or more of the transaction data entries included in the identified subset;
executing, by the querying module of the processing server, a query on the event database to identify a personalized itinerary comprised of a plurality of itinerary events, wherein the geographic location and selection criteria included in the related event profile for the respective itinerary event corresponds to the geographic area and one or more purchase behaviors, respectively, and where a number of the plurality of itinerary events is based on the time allotment included in the related event profile for each of the itinerary events and the time and date range; and
electronically transmitting, by a transmitting device of the processing server, the personalized itinerary to the computing system.

2. The method of claim 1, further comprising:
ordering, by the analytical module of the processing server, the plurality of itinerary events based on at least the event type and time allotment included in the related event profile, wherein the ordering is performed prior to electronically transmitting the personalized itinerary.

3. The method of claim 1, further comprising:
receiving, by the receiving device of the processing server, a replacement request from the computing system, wherein the replacement request indicates a selected one of the plurality of itinerary events;
executing, by the querying module of the processing server, a query on the event database to identify a replacement event profile based on at least a correspondence between the included event type and time allotment and the event type and time allotment included in the event profile related to the selected itinerary event, and a correspondence between the included selection criteria and the one or more purchase behaviors;
replacing, by the analytical module of the processing server, the selected one of the plurality of itinerary events with the itinerary event related to the identified replacement event profile to update the personalized itinerary; and
electronically transmitting, by the transmitting device of the processing server, the updated personalized itinerary to the computing system.

4. The method of claim 1, wherein
each transaction data entry further includes a geographic location, and
the geographic location included in each transaction data entry included in the identified subset is included in the geographic area.

5. The method of claim 1, wherein
the itinerary request is written in natural language, and
the method further comprises:
processing, by a natural language processing module of the processing server, the itinerary request to identify the account identifier, geographic area, and time and date range.

6. A method for delivery of personalized event recommendations, comprising:
storing, in a transaction database of a processing server, a plurality of transaction data entries, wherein each transaction data entry is a structured data set related to a payment transaction including at least an account identifier and transaction data;
storing, in an event database of the processing server, a plurality of event profiles, wherein each event profile is a structured data set related to an itinerary event including at least a geographic location, a time allotment, an event type, and one or more selection criteria;
receiving, by a receiving device of the processing server, an event request, wherein the event request is written in natural language;
processing, by a natural language processing module of the processing server, the event request to identify at least a specific event type, a geographic area, and a specific account identifier;
executing, by a querying module of the processing server, a query on the transaction database to identify a subset of transaction data entries where the included account identifier corresponds to the specific account identifier;
identifying, by an analytical module of the processing server, one or more purchase behaviors based on the transaction data included in one or more of the transaction data entries included in the identified subset;
executing, by the querying module of the processing server, a query on the event database to identify a specific event profile based on at least a correspondence between the included event type and the specific event type, the included geographic location and the geographic area, and the included one or more selection criteria and the identified one or more purchase behaviors; and
electronically transmitting, by a transmitting device of the processing server, the itinerary event related to the identified specific event profile to a computing system.

7. The method of claim 6, further comprising:
generating, by the natural language processing module of the processing server, a natural language response, wherein the natural language response includes the itinerary event related to the identified specific event profile, wherein
the electronic transmission of the itinerary event to the computing system comprises electronically transmitting the natural language response to the computing system.

8. The method of claim 6, wherein
each transaction data entry further includes a geographic location, and
the geographic location included in each transaction data entry included in the identified subset is included in the geographic area.

9. The method of claim 6, wherein
processing the event request further includes identifying a time and date range, and
the specific event profile is further identified based on a correspondence between the included time allotment and the time and date range.

10. The method of claim 6, wherein the event request is received via an application programming interface from a live messaging application executed by the computing system.

11. A system for delivery of a personalized itinerary, comprising:
a transmitting device of a processing server;
a transaction database of the processing server configured to store a plurality of transaction data entries, wherein each transaction data entry is a structured data set related to a payment transaction including at least an account identifier and transaction data;
an event database of the processing server configured to store a plurality of event profiles, wherein each event profile is a structured data set related to an itinerary event including at least a geographic location, a time allotment, an event type, and one or more selection criteria;
a receiving device of the processing server configured to receive an itinerary request from a computing system, wherein the itinerary request includes at least a specific account identifier, a geographic area, and a time and date range;
a querying module of the processing server configured to execute a query on the transaction database to identify a subset of transaction data entries where the included account identifier corresponds to the specific account identifier; and
an analytical module of the processing server configured to identify one or more purchase behaviors based on the transaction data included in one or more of the transaction data entries included in the identified subset, wherein
the querying module of the processing server is further configured to execute a query on the event database to identify a personalized itinerary comprised of a plurality of itinerary events, wherein the geographic location and selection criteria included in the related event profile for the respective itinerary event corresponds to the geographic area and one or more purchase behaviors, respectively, and where a number of the plurality of itinerary events is based on the time allotment included in the related event profile for each of the itinerary events and the time and date range, and
the transmitting device of the processing server is configured to electronically transmit the personalized itinerary to the computing system.

12. The system of claim 11, wherein the analytical module of the processing server is further configured to order the plurality of itinerary events based on at least the event type and time allotment included in the related event profile, wherein the ordering is performed prior to electronically transmitting the personalized itinerary.

13. The system of claim 11, wherein
the receiving device of the processing server is further configured to receive a replacement request from the computing system, wherein the replacement request indicates a selected one of the plurality of itinerary events,
the querying module of the processing server is further configured to execute a query on the event database to identify a replacement event profile based on at least a correspondence between the included event type and time allotment and the event type and time allotment included in the event profile related to the selected itinerary event, and a correspondence between the included selection criteria and the one or more purchase behaviors,
the analytical module of the processing server is further configured to replace the selected one of the plurality of itinerary events with the itinerary event related to the identified replacement event profile to update the personalized itinerary, and
the transmitting device of the processing server is further configured to electronically transmit the updated personalized itinerary to the computing system.

14. The system of claim 11, wherein
each transaction data entry further includes a geographic location, and
the geographic location included in each transaction data entry included in the identified subset is included in the geographic area.

15. The system of claim 11, further comprising:
a natural language processing module of the processing server, wherein
the itinerary request is written in natural language, and
the natural language processing module of the processing server is configured to process the itinerary request to identify the account identifier, geographic area, and time and date range.

16. A system for delivery of personalized event recommendations, comprising:
a transmitting device of the processing server;
a transaction database of the processing server configured to store a plurality of transaction data entries, wherein each transaction data entry is a structured data set related to a payment transaction including at least an account identifier and transaction data;
an event database of the processing server configured to store a plurality of event profiles, wherein each event profile is a structured data set related to an itinerary event including at least a geographic location, a time allotment, an event type, and one or more selection criteria;
a receiving device of the processing server configured to receive an event request, wherein the event request is written in natural language;
a natural language processing module of the processing server configured to process the event request to identify at least a specific event type, a geographic area, and a specific account identifier;
a querying module of the processing server configured to execute a query on the transaction database to identify a subset of transaction data entries where the included account identifier corresponds to the specific account identifier; and
an analytical module of the processing server configured to identify one or more purchase behaviors based on the transaction data included in one or more of the transaction data entries included in the identified subset, wherein
the querying module of the processing server is further configured to execute a query on the event database to identify a specific event profile based on at least a correspondence between the included event type and the specific event type, the included geographic location and the geographic area, and the included one or more selection criteria and the identified one or more purchase behaviors, and
the transmitting device of the processing server is configured to electronically transmit the itinerary event related to the identified specific event profile to a computing system.

17. The system of claim 16, wherein
the natural language processing module of the processing server is further configured to generate a natural language response, wherein the natural language response includes the itinerary event related to the identified specific event profile, and
the electronic transmission of the itinerary event to the computing system comprises electronically transmitting the natural language response to the computing system.

18. The system of claim 16, wherein
each transaction data entry further includes a geographic location, and
the geographic location included in each transaction data entry included in the identified subset is included in the geographic area.

19. The system of claim 16, wherein
processing the event request further includes identifying a time and date range, and
the specific event profile is further identified based on a correspondence between the included time allotment and the time and date range.

20. The system of claim 16, wherein the event request is received via an application programming interface from a live messaging application executed by the computing system.
